(19) United States
(12) Patent Application Publication
(10) Pub. No.: US 2004/0017395 A1
(43) Pub. Date: Jan. 29, 2004

(54) System and method for configuring and managing enterprise applications

(76) Inventor: Thomas A. Cook, Boulder, CO (US)

Correspondence Address: Sheldon R. Meyer, FLIESLER DUBB MEYER & LOVEJOY LLP, Fourth Floor, Four Embarcadero Center, San Francisco, CA, 94111-4156, US

(21) Appl. No.: 10/414,894

(22) Filed: Apr. 16, 2003

Related U.S. Application Data
(60) Provisional application No. 60/373,153, filed on Apr. 16, 2002.

(51) Int. Cl. G09G 5/00

(52) U.S. Cl. 345/745

(57) ABSTRACT

A system and method for configuring an enterprise application, comprising a first graphical user interface (GUI) to create and/or manage a segment, a second GUI to create and/or manage a promotional campaign wherein the promotional campaign contains at least one scenario, and/or a third GUI to create and/or manage at least one of (1) a query and (2) a condition.

### CLAIM OF PRIORITY

This application claims priority from ENHANCED PORTALS [FLAGSTAFF RELEASE], U.S. Provisional Application No. 60/373,153, Inventor: Thomas A. Cook, filed on Apr. 16, 2002, and which is incorporated herein by reference. (Attorney's docket no. BEAS-1273US0.)

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

The present invention disclosure relates to graphical tools for maintaining software systems, and in particular, enterprise applications.

### BACKGROUND

Enterprise applications typically include a graphical user interface such as a portal accessible on the World Wide Web, a middle tier including a application server and an application framework, and a back-end comprising a relational database and legacy applications. Despite their inherent power, enterprise applications can be difficult to maintain due to their multi-faceted nature and overall complexity. Configuring and managing such applications can require specialized knowledge and experience. Users without such skills are in the position of having to depend on others to do their bidding. Such an arrangement can be both frustrating for unskilled users and not very cost-effective from a management perspective.

### BRIEF DESCRIPTION OF THE DRAWINGS

FIG. 1 is an illustration of an exemplary e-business control center (EBCC) in accordance to one embodiment of the invention.

FIG. 2 is an illustration of a EBCC customer segment editor in one embodiment of the invention.

FIG. 3 is an illustration of a placeholder editor in one embodiment of the invention.

FIG. 4 is an illustration of a discount editor in one embodiment of the invention. The EBCC offers three discount types.

FIG. 5 is an illustration of a campaign editor in one embodiment of the invention.

FIG. 6 is an illustration of a graphical Webflow editor in one embodiment of the invention.

### DETAILED DESCRIPTION

The present invention includes a system and method for configuring and managing enterprise applications.

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will be apparent to one skilled in the art that the present invention may be practiced without the specific details. In other instances, well-known features are omitted or simplified in order not to obscure the present invention.

Parts of the description will be presented in data processing terms, such as data, selection, retrieval, generation, and so forth, consistent with the manner commonly employed by those skilled in the art to convey the substance of their work to others skilled in the art. As well understood by those skilled in the art, these quantities take the form of electrical, magnetic, or optical signals capable of being stored, transferred, combined, and otherwise manipulated through electrical and/or optical components of a processor and its subsystems.

Various operations will be described as multiple discrete steps in turn, in a manner that is most helpful in understanding the present invention, however, the order of description should not be construed as to imply that these operations are necessarily order dependent. In particular, these operations need not be performed in the order of presentation.

Various embodiments will be illustrated in terms of exemplary classes and/or objects in an object-oriented programming paradigm. It will be apparent to one skilled in the art that the present invention can be practiced using any number of different classes/objects, not merely those included here for illustrative purposes. Furthermore, it will also be apparent that the present invention is not limited to any particular software programming language or programming paradigm.

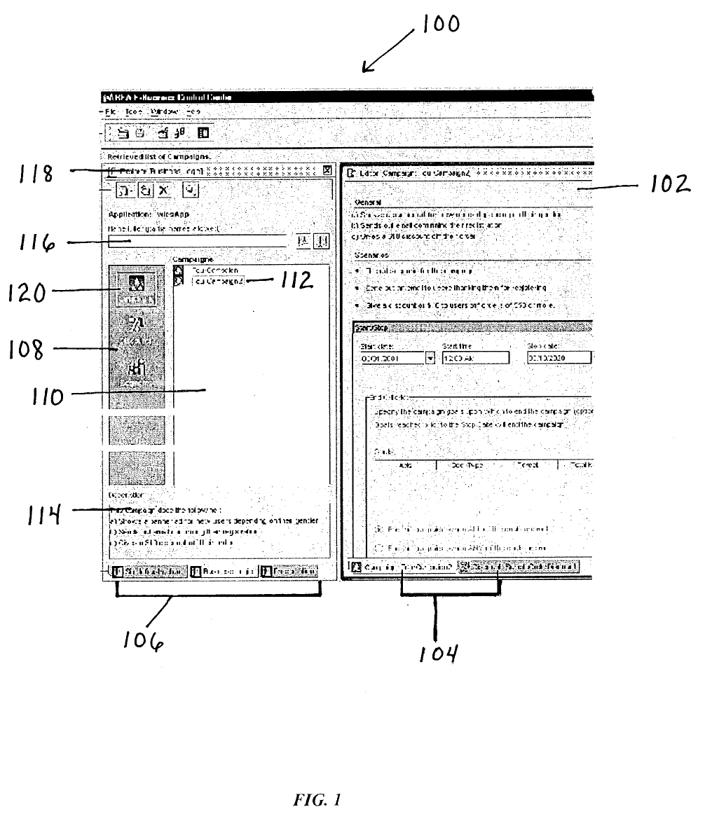

FIG. 1 is an illustration of an exemplary e-business control center (EBCC) in accordance to one embodiment of the invention. The EBCC has a graphical user interface (GUI) that can be implemented in a number of ways, including but not limited to: page description languages such as Hypertext Markup Language (HTML) and/or windowing environments such as Microsoft Windows® (available from Microsoft Corp., of Redmond, Wash.). Objects depicted in the GUI 100 of FIG. 1 can be selected with an input device such as a mouse, a voice command, a gesture, etc. Explorer window 118 can be used to access different tools in the EBCC. Tool palette 108 lists available tools including the currently selected tool 120. Pane 110 contains project files associated with the currently selected tool 120. Filename filter 116 can be used to filter files displayed in pane 110 by specifying a filename patter and/or a regular expression. A description of a selected project file 112 can be provided in window region 114. Explorer tabs 106 provide a means for accessing functionality within the currently selected tool. Editor window 102 contains a context-sensitive editor which can be automatically activated based on the currently selected project file 112. Different project files can be edited in editor window 102 and can be selected using tabs 104.

In one embodiment, the EBCC can control aspects of an enterprise application as detailed in Table 1.

TABLE 1
EBCC Functionality in an Embodiment

| FUNCTIONAL | |
|---|---|
| AREA | DESCRIPTION |
| Control | Webflow is a means of programmatically controlling |
| Webflow | portal web page navigation. A Webflow tool allows a |
| | user to specify the order in which pages are displayed |
| | to a portal's customers, and can be used to invoke |
| | predefined, specialized components that execute back- |
| | end business logic. |
| Track customer | Customer behaviors or events that can be tracked range |
| behavior | from viewing content to clicking through hyperlinks |
| (events) | (“select-throughs”). |
| Define customer | Organize customers into groups, or customer seg- |
| segments | ments, based on common characteristics. Customer |
| | segments may then be used to customize aspects of an |
| | enterprise application to suit the needs of different |
| | segments. |
| Create | A placeholder is a region of a web page where content |
| placeholders for | may be displayed. In the EBCC, a user can associate |
| advertisement | queries with a placeholder that can be used to |
| display | automatically retrieve and display targeted content in |
| | the placeholder. Each time customers view a page |
| | containing a placeholder, they may see different |
| | content in the placeholder, depending on the priorities |
| | that have been set on the queries and the |
| | advertisements. Placeholders can also be used to track |
| | the number of times advertisements are displayed by a |
| | placeholder (advertisement impressions) and the |
| | number of select-throughs. |
| Target | Content selectors allow a user to dynamically match |
| customers with | Web content to customers in real-time, based on events |
| personalized | that occur when a customer visits a Web site, customer |
| content | characteristics that are most often stored in customer |
| | profiles, or dates and times. |
| Configure | The portal, portlet, and entitlement segment tools |
| Portals, Portlets, | allow a user to configure a portal and determine which |
| and Entitlement | users have access to specific portal content. The portal |
| Segments. | tool allows a user determine elements such as layout, |
| | skins and pages used in the portal, and the portlets that |
| | are part of the portal. The portlet tool allows a user to |
| | specify uniform resource locators (URL's) to content, |
| | Webflow, and configure other aspects of portlets. The |
| | entitlement segments tool allows a user to determine |
| | which customers or groups see specific portal content. |
| Define stand- | As part of a marketing effort, a user might want to |
| alone discounts | temporarily give customers a discount on particular |
| | items in product catalog. Using the EBCC, a user can |
| | define stand-alone discounts by specifying the |
| | percentage or dollar amount off, whether the discount |
| | applies on a per-item, set-based, or per-order basis, the |
| | products to which the discount applies, and so on. If a |
| | customer purchases multiple items and is likely to |
| | qualify for more than one discount, a priority can be |
| | associated with each discount to help resolve any |
| | conflicts and ensure that customers receive the |
| | discount(s) the user intended. |
| Define | Campaign discounts are specifically designed for use |
| campaign | within promotional campaigns. They are offered to |
| discounts | customers who belong to a particular customer |
| | segment, who exhibit particular browsing behaviors, or |
| | meet other predefined criteria. With the EBCC, a user |
| | can define campaign discounts and apply them in |
| | various ways to meet targeted marketing objectives. |
| Execute and | Using predefined customer segments, tracked customer |
| manage | behaviors, and previously established campaign |
| promotional | discounts, a user can create, execute, and maintain |
| campaigns | promotional campaigns. |
| Monitor and | Events and Behavior Tracking can be used to monitor |
| report campaign | and qualify promotional campaign results. |
| results | |

The EBCC provides a user with a number of predefined conditions which can be used programmatically in many of the functional areas described in Table 1. These conditions are described in Table 2.

TABLE 2
Conditions in an Embodiment

| CONDITION | DESCRIPTION |
|---|---|
| The customer is a | If a customer to Web site belongs to a predefined |
| member of a | customer segment, execute the specified action. By |
| predefined customer | way of a non-limiting example, if the customer is a |
| segment | Gold Customer (customer segment), give the |
| | customer a 15% discount (action). |
| The customer has | If a customer's characteristics are compared to |
| specific character- | values and those comparisons evaluate to true, |
| istics | execute a specified action. By way of a non- |
| | limiting example, if the customer's salary |
| | (characteristic) is greater than or equal to |
| | (comparison) $50,000 (value), send the customer |
| | an e-mail (action). |
| The HTTP session | A Hypertext Transfer Protocol (HTTP) session's |
| has specific proper- | properties are compared to values a user specifies |
| ties | and if those comparisons evaluate to true, execute a |
| | specified action. |
| An HTTP request | An HTTP request's properties are compared to |
| has specific proper- | values a user specifies and if those comparisons |
| ties | evaluate to true, execute a specified action. |
| An event has | If a specified event occurs, execute the specified |
| occurred | action. By way of a non-limiting example, if a |
| | customer has logged in (event), display an |
| | advertisement that matches their interests (action). |
| | Events may be selected from a number of |
| | predefined event types. |
| An event has | An event's characteristics are compared to values a |
| specific character- | user specifies, and if those comparisons evaluate to |
| istics | true, execute a specified action. By way of a non- |
| | limiting example, if a customer adds more than 5 |
| | items to their shopping cart (event), give the |
| | customer a 10% discount (action). |
| The date is | If the current date is equal to the one a user |
| | specifies, execute a specified action. By way of a |
| | non-limiting example, if the date is equal to |
| | Jul. 22, 2001, send customers an e-mail about an |
| | upcoming sale (action). The current date refers to |
| | the date at the point that the condition is evaluated |
| | for a given customer visiting the Web site. |
| It is after a given | If the current date is after a date a user specifies, |
| date | execute a specified action. By way of a non- |
| | limiting example, if the date is after Dec. 18, 2000, |
| | offer customers a discount (action). The |
| | current date refers to the date at the point that the |
| | condition is evaluated for a given user visiting the |
| | Web site. |
| It is after a given | If the current date and time is after a date and time |
| date and time | a user specifies, execute a specified action. By way |
| | of a non-limiting example, if the date and time is |
| | after Jul. 22, 2001 at 3 p.m., send customers an e- |
| | mail about an upcoming sale (action). The current |
| | date and time refers to the date and time at the |
| | point that the condition is evaluated for a given |
| | user visiting the Web site. |
| It is between two | If the current time falls within a range of times a |
| times | user specifies, execute a specified action. By way |
| | of a non-limiting example, if the time is between 3 |
| | p.m. and 5 p.m., offer customers a discount |
| | (action). The current time refers to the time at the |
| | point that the condition is evaluated for a given |
| | user visiting the Web site. |
| It is between two | If the current date falls within a range of dates a |
| dates | user specifies, execute the specified action. By |
| | way of a non-limiting example, if the date is |
| | between Dec. 18, 2000 and Dec. 18, 2001, |
| | show customers a sale advertisement |
| | (action). The current date refers to the date at the |
| | point that the condition is evaluated for a given |
| | user visiting the Web site. |
| It is between two | If the current date and time fall within a range of |
| dates/times | dates and times a user specifies, execute the |
| | specified action. By way of a non-limiting |
| | example, if the date and time is between Jul. 22, |
| | 2000 at 3 p.m. and Jul. 22, 2001 at 3 p.m., show |
| | customers a sale advertisement (action). In one |
| | embodiment, the range of dates is inclusive. In one |
| | embodiment, the current date and time refers to the |
| | date and time at the point that the condition is |
| | evaluated for a given user visiting the Web site. |
| There is a specific | If an item a user specifies exists in a customer's |
| item in the shopping | shopping cart, execute the specified action. By |
| cart | way of a non-limiting example, if a customer has |
| | an item with a SKU equal to T144 in their shopping |
| | cart, give the customer a 10% discount (action). |
| There is an item | If an item from a product category a user specifies |
| from a given cate- | exists in the customer's shopping cart, execute the |
| gory in the shopping | specified action. By way of a non-limiting |
| cart | example, if the customer has an item from Books |
| | (product category) in their shopping cart, give the |
| | customer a 10% discount (action). |
| The value of items | If the value of the items in a customer's shopping |
| in the cart is a cer- | cart meets the criteria a user specifies, execute the |
| tain amount | specified action. By way of a non-limiting |
| | example, if the customer has $100 worth (value) of |
| | items in their shopping cart, send them a “thank |
| | you” e-mail (action). |
| A random number | When a customer visits a Web site, the system |
| falls within a given | assigns the customer a random number from 1 to |
| range | 100. If the customer's random number falls within |
| | the numeric range specified by a user, execute the |
| | action. By way of a non-limiting example, if a user |
| | specifies a range of 1 to 50, the action will be |
| | executed for approximately 50% of the target |
| | customer population. |

In one embodiment, the EBCC allows for the definition of property sets. A property set is a convenient way to give a name to a group of properties for a specific purpose. By way of a non-limiting example, a user profile property set named Customer Properties could include properties such as First Name, Last Name, Home Phone, Email, and Customer Type. A property editor (not shown) enables an EBCC user to give a new property a name and a description, assign a data type, a selection mode, and a value range, and create a list of possible values for the property. In the most general sense, a property can be considered a name/value pair. Property sets serve as namespaces for properties so that properties can be conveniently grouped and so that multiple properties with the same name can be defined. In one embodiment, property sets can be used in six functional areas as described in Table 3.

TABLE 3
Property Set Functional Areas in an Embodiment

| FUNCTIONAL | |
|---|---|
| AREA | DESCRIPTION |
| User Profiles | The User Profiles property set type can be used for |
| | defining the property sets and properties that apply to |
| | user and group profiles. By way of a non-limiting |
| | example, a property set of this type might be created |
| | called “CustomerProperties.” Subsequent property |
| | retrieval for a particular user or group can then be |
| | scoped with this property set name to retrieve the |
| | users's email address. |
| HTTP Requests | An HTTP Request is the information that browser |
| | sends to the server; the server sends back an HTTP |
| | response. The Request property set type is used for |
| | defining the property sets and properties that apply to |
| | HTTP requests. |
| HTTP Sessions | A session contains short-lived, stateful information for |
| | the time that a browser is interacting with a server. |
| | Session property set type is used for defining the |
| | property sets and properties that apply to HTTP |
| | sessions. A “Session” property set type might be |
| | called “myApplicationSession.” |
| Catalog Structure | The Catalog Structure property set type is used to |
| | define custom attributes for product items and product |
| | categories in the Commerce services catalog. These |
| | custom attributes can be used in addition to the default |
| | attributes provided by Commerce services in the |
| | catalog database tables |
| Events | The Events property set type is used to register a |
| | custom event. For the purpose of registering an event, |
| | you can consider an event property as a name-value |
| | pair. During the registration of a custom event, you |
| | specify the event's name, description, and one or more |
| | properties. Each property has a range, type of |
| | permissible value, and default value. The information |
| | you need to register an event should be available from |
| | your Business Engineer (BE) or Java developer. |
| Content | The Content Management property set type is used for |
| Management | defining the configuration and run-time use of the |
| | content management system. |

In one embodiment, properties can include the following information:

Property name—the name of the property, such as Gender. Within a single property set, all properties can have a unique name. However, property names can be re-used in different property sets.

Data type—specifies the data type of the property value. The possible values include Text, Numeric, Floating-Point number (equivalent to Double in Java), Boolean, and Date/Time.

Selection mode—specifies whether a property is single-valued (has a single default value) or multi-valued (has a collection of default values).

Value range—specifies whether the defaults are restricted to one specific value, one or more specific values, or any value.

Optionally, property definitions can also include the following:

Description—a textual description of the property.

Values—a user can assign a list of values from which a customer will pick, and the user can designate which of the values is the default.

A combination of property values is possible:

Boolean: The values for this type of property are either True or False. A user can choose the default. The default value is displayed only in the Enter Property Values Window, not in the Edit Event Property window. When this data type is selected, the Selection mode and Value range are unavailable.

Single, Unrestricted: This type of property has only one value, which is also the default value.

Single, Restricted: This type of property has multiple available values and a single default value. A user can select which value is the default. An instance of this property can have only one value assigned. By way of a non-limiting example, the property Favorite_Day_of_the_Week would have seven available values, but an instance of the property can have only one value (Saturday).

Multiple, Restricted: This type of property has multiple available values. A user can select one or more values as default values. An instance of this property can have multiple values assigned. By way of a non-limiting example, the property Favorite_Days_of_the_Week would have seven available values, and an instance of the property can have any number of values (Friday, Saturday, Sunday).

Multiple, Unrestricted: This type of property has multiple values. A user cannot select any defaults; all values are defaults.

In one embodiment, entities in an enterprise application (e.g., customers to a website, content to be shown to customers, and events that represent customer behavior) can be described by their characteristics or properties. Related properties can be grouped together for convenience into property sets. Entities in an enterprise application may have one or more property sets associated with them. An EBCC user can build descriptors based on property sets that describe entities of interest.

In one embodiment, a descriptor can be comprised of a property phrase and a value phrase. By way of a non-limiting example, a user may be interested in targeting an electronic mail (e-mail) to customers whose income range is $75,000-$99,000. In one embodiment, the Descriptor could be:

Demographics: Income_Range is equal to “$75,000-$99,000”

In the example above, “Demographics” is the property set in which a user would find the “Income_Range” property, “Is Equal” is a comparison, and “$75,000=$99,000” is the value. Together, the property set and property form the following Property Phrase:

Demographics: Income_Range

Together, the comparison and the value form the following Value Phrase:

is equal to “$75,000-$99,000”

A customer segment is a grouping of customers based on common characteristics, such as product preferences or age. Each piece of information stored in a customer's profile (or any combination of that information) can be used to create a customer segment. By way of a non-limiting example, a user might create a customer segment named Office Supply Junkie, which would include the customers janedoe and asmith. Similarly, a customer segment named Over21 would include the customers janedoe and jblack, based on their Date of Birth profile information.

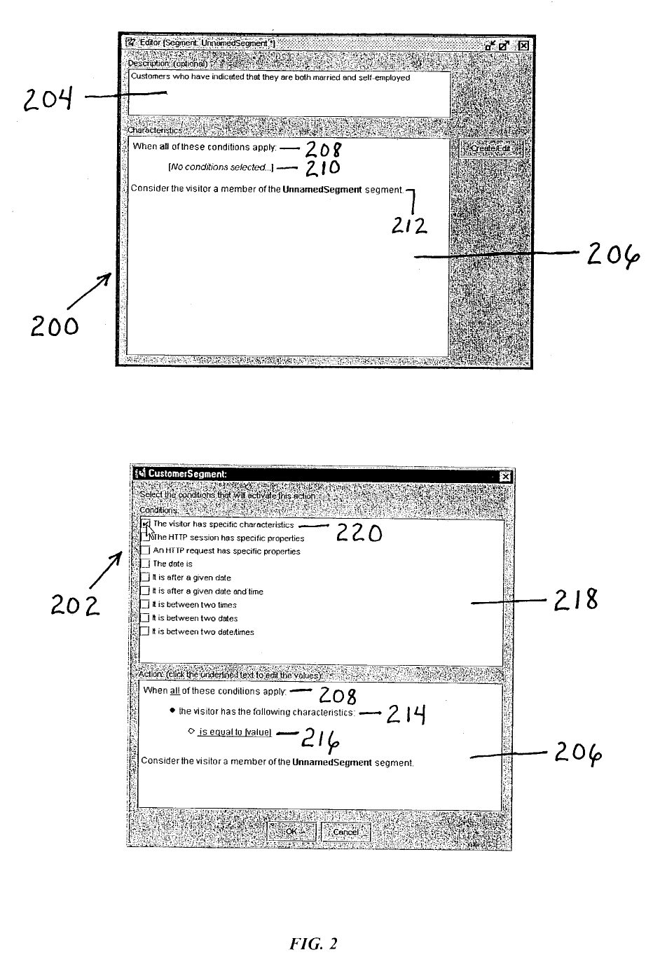

FIG. 2 is an illustration of a EBCC customer segment editor in one embodiment of the invention. Segment editor window 200 has a description area 204 in which an EBCC user can enter a textual description of a segment. Conditions for the segment can be specified by the user in characteristics area 206. Conditions can be specified in easy-to-understand phrases. Phrase 208 specifies that ali of its conditions must be met in order for the customer to be considered in the segment named by default “UnnamedSegment” defined in phrase 212. By selecting phrase 212, an EBCC user can rename the segment. Instead of all of the conditions having to be met in phrase 208, “all” could be replaced with “any” such that phrase 208 operates like a logical OR. The editor displays an empty condition set 210 by default. If a user selects phrase 210, window 202 appears. Window 202 lists all available conditions in pane 218 (see Table 2). The user can select each condition that applies to the segment. In this example, the user has selected condition 220. This is reflected in the characteristics area 206: the empty condition 210 has been replaced by the selected condition 214. In addition, a value condition 216 associated with the condition 214 can be selected by the user to specify what characteristics a customer/visitor should have for the condition to be satisfied.

Customer segments can be used in conjunction with content selectors to personalize a customer's portal experience. A content selector is a mechanism used to retrieve content (e.g., documents) from a content management system. Using content selectors, an EBCC user can specify the conditions under which one or more documents are retrieved. If a user specifies a customer's membership in a segment as one of these conditions, a user can specify that a particular piece of content be selected from the content management system and be displayed to that customer. By way of a non-limiting example, customers who belong to an Office Supply segment may be shown an article titled: “Reducing Desk Clutter With Stackable Organizers.”

In one embodiment, content selectors can consist of the following elements:

A set of conditions (see Table 2) that determine when the content selector queries a content management system. The conditions can use such things as the profile of the customer who is currently viewing a JSP page, an event that occurs on the page or has occurred previously on some other page, or the current time.

A query that searches the content management system for one or more documents.

A Java ServerPage™ (JSP) tag that triggers the content selector to evaluate its conditions. JSP is available from Sun Microsystems, Inc.

Content selector queries search through descriptions (attributes) that the are attached to documents in a content management system. In one embodiment, documents that are stored in a content management system can have properties associated with them that describe their contents. By way of a non-limiting example, all documents can have system properties such as author, creation date, and modification date. A user can also add custom properties to documents that more specifically describe the documents. By way of a further non-limiting example, for advertisement graphics, a user can add properties (e.g., metadata) for company name and product name.

In one embodiment, an EBCC user can construct queries in the following ways:

By comparing one or more document properties to a value or range of values.

By way of a non-limiting example, a user may want to display advertisements for ACME mutual funds in an advertisement placeholder. The content management system uses a property named productName to indicate the name of the mutual fund that a document advertises. A user can construct a query that finds all documents for which the productName property contains ACME.

By comparing one or more document properties with properties of some other objects.

By way of a non-limiting example, a user may want a content selector to display documents that describe investing in mutual funds. The content management system uses a document property called investorRiskLevel to identify whether a document describes an investment that is aggressive, moderate, or conservative. A customer profile can also include a property called investorRiskLevel to indicate whether a customer prefers aggressive, moderate, or conservative investments. A user constructs a query that finds all documents for which the investorRiskLevel property contains a value that is equal to the value of a customer's investorRiskLevel property.

An integral part of most e-commerce Web sites is displaying advertisements and tracking customers' responses. In one embodiment, a user can develop placeholders to display advertisements and manage and evaluate the effectiveness of advertising strategy. Placeholders are predefined areas on a Web page that can be used to display advertisements and other content. In one embodiment, placeholders can be defined in JSPs and queries can then be added to those placeholder files in the EBCC. Advertisement placeholders can display any type of content, including the following types of documents:

HTML and/or XHTML

XML

Images

Shockwave files

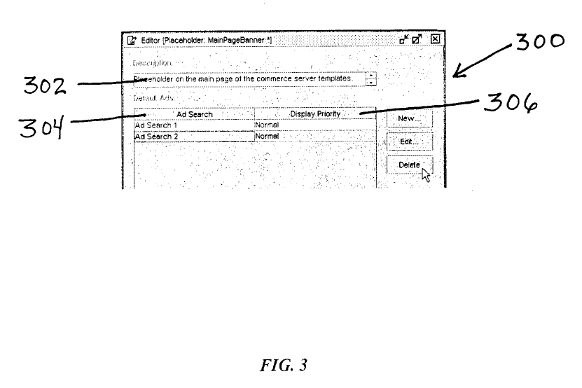

FIG. 3 is an illustration of a placeholder editor in one embodiment of the invention. Placeholder editor window 300 contains a description area 302 in which a textual description of the placeholder can be entered by an EBCC user. Advertisement Search column 304 lists all queries that will be run against this placeholder. Display Priority column 306 shows the associated priority for each query in column 304. An EBCC user can add or remove queries from column 304, and change the priority of each in column 306.

In some cases, a single query can apply to multiple advertisements in the database. For example, an EBCC user can put a query in a placeholder that looks in an advertisement database for all files whose names contain “bird.” In that case, a placeholder with a single query can display multiple advertisements. After the server determines which query to run in a placeholder, that query could return more than one advertisement. If this happens, an application server needs to determine which advertisement to display in the placeholder. In one embodiment, a user can establish preferences for advertisements that should be displayed more frequently than other advertisements by creating a document attribute called adWeight in content management system. A user assigns a higher number to the advertisements that a user want to be displayed more frequently than others. In this way, the application server can pick the add with the highest weight to display.

In one embodiment, one advertisement can be displayed in an advertisement placeholder at any given time. An advertisement placeholder can contain many queries, especially if a user use WebLogic Portal with multiple campaigns active concurrently. The display priority 306 gives a query greater or lesser chance that it will be evaluated by the placeholder. To establish preferences for queries that should run more frequently than other queries, a user can attach a priority to a query when a user creates it. Before it runs a query, an advertisement placeholder evaluates all of the relative priorities of the queries that it contains. On average, an advertisement query with a higher priority will run more frequently than a query with a lower priority. However, in any single instance, it is possible that a placeholder runs a query with a lower priority than other queries.

In addition to the properties that placeholder queries use to find documents, placeholders can use document properties to do the following:

Create a target URL for clickthrough behavior on images.

Determine whether the target for a clickthrough of an image advertisement is displayed in a popup window. The advertisement placeholder generates the necessary JavaScript to display the popup window, and it can generate a link that customers select to close the popup window.

Set the quality parameter for a Shockwave file.

In one embodiment, stand-alone discounts are discounts that are offered to everyone shopping at website. They are not based on a customer's behavior or controlled by campaigns. An example of a discount used as a stand-alone discount is, “give everyone 10% off books.” An EBCC user defining a stand-alone discount may want to provide a discount explanation and a discount description. A discount explanation identifies the discount to customers while they are checking out, or at some other time during their shopping experience. A discount description will help a user identify the discount when a user are trying to distinguish it from others listed in the EBCC.

In addition to the discount usage (stand-alone or campaign), discount definitions can also include the following information:

Discount Duration

Discount Types

Discount Limits

Discount Priorities

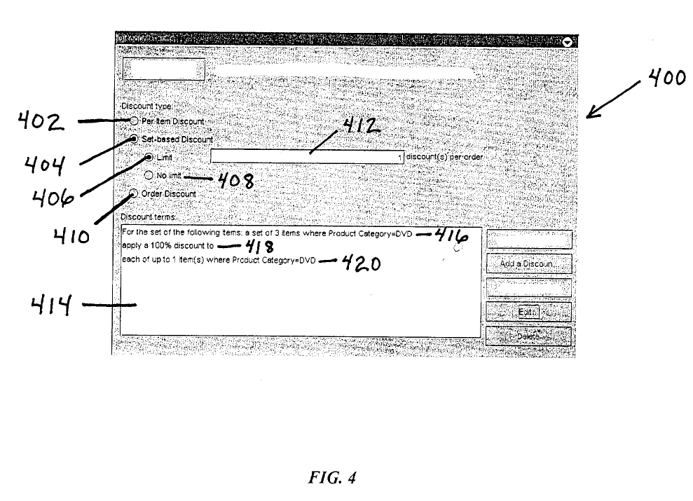

FIG. 4 is an illustration of a discount editor in one embodiment of the invention. The EBCC offers three discount types. Discount editor window 400 has a discount terms area 414 in which an EBCC user can fine-tune the discount type as selected from 402-410. A user fine-tunes a discount term by selecting it and then adjusting its default values (not shown). Discount terms area 414 is generally used to specify a set of items a discount applies to (416), how much of a discount is to be given (418), and how the discount is to be applied (420). The three discount types are:

Per Item Discounts

Set-Based Discounts

Order Discounts

Per item discounts (402) are discounts that apply to individual items in a product catalog. Per item discounts can be offered to customers based on a customer's purchase of the following:

Any item (regardless of SKU or product category).

Specific items in a product catalog (specified by SKU).

Any items belonging to a particular product category.

A combination of items specified by SKU and product category.

Per item discounts can apply to the following:

The same items that triggered the discount offer.

Any items in the product catalog (regardless of SKU or product category).

Specific items in the product catalog (specified by SKU).

Any items belonging to a particular product category.

A combination of items specified by SKU and product category.

Per item discounts can be applied per item. By way of a non-limiting example, a user may specify that for every item purchased from the product category Sports Equipment, customers will receive $5 off every baseball cap purchased. When customers purchase a baseball, a glove, and a bat (all items belonging to the category Sporting Equipment, they will be eligible for a discount on each baseball cap. For instance, if a customer also purchases two baseball caps, the discount will be $10. Per item discounts can be specified as a percentage off, an amount off, or a fixed price.

Set-based discounts (404) are useful when a user wants to offer a single discount based on the customer having a specified set of product items in their shopping cart. Set-based discounts can be offered to customers based on a customer's purchase of the following:

Sets of any item (regardless of SKU or product category).

Sets of specific items in product catalog (specified by SKU).

Sets of product items belonging to a particular category.

Sets created by a combination of product items specified by SKU and product categories.

Set-based discounts can apply to the following:

The same items that triggered the discount offer.

Any items in the product catalog (regardless of SKU or product category).

Specific items in product catalog (specified by SKU)

Any items belonging to a particular category

Specific items specified by SKU or product category.

Set-based discounts will be applied per set. By way of a non-limiting example, a user may specify that for every set of three items purchased from the product category Sporting Equipment, customers will receive $5 off a baseball cap. When customers purchase a baseball, a glove, and a bat (all items belonging to the Sporting Equipment category), they can receive $5 off one baseball cap, for a total discount of $5. Unlike the per item discount (described previously) where the customer gets a $10 discount for also purchasing two caps, the set-based discount would be $5. Set-based discounts can be specified as a percentage off, an amount off, or a fixed price.

Order discounts (410) are discounts that can apply to a customer's entire order. Order discounts can be offered to customers (that is, triggered) based on the following:

Any order.

A specified order subtotal.

Order discounts can apply to the following:

The order total.

The shipping cost of the order.

The EBCC provides a user with several ways to limit the application of discounts. An overall limit specifies the number of orders to which a discount can be applied for a given customer. The overall limit can be a value equal to or greater than 1. By way of a non-limiting example, if store offers a 10% discount off books with an overall limit of 2. This means that customers can receive the 10% discount for no more than 2 orders containing books. If there were no overall limit, customers could return to the Web site and place separate orders to receive more discounts.

Order limits define how many times the discount can be used per order. A user can specify order limits either based on the items that triggered the discount, or on the target items to which the discount is applied (which may or may not be the same items). By way of a non-limiting example, a user may want to give away 2 DVD movies with the purchase of every DVD player a user sell, with a limit of one giveaway per order. In this case, a user would impose the order limit of 1 on the trigger item, the single DVD player. Any additional DVD players in the order would not trigger additional discounts; the customer would receive only 2 DVD movies free.

For per-item discounts, a user can use the EBCC to specify a minimum purchase requirement. The minimum purchase requirement can be a value equal to or greater than 1. Once the minimum requirement has been met in a given order, the discount will be earned for each additional item. By way of a non-limiting example, if the minimum purchase requirement is 3 items, customers who buy 5 items will receive 5 discounts.

A discount priority is a setting within the EBCC that allows a user to specify the relative importance of a discount. The discount priority is a value in the range of 1-20, with one being the highest priority. In the event that two or more discounts are applicable to a given item, the priority associated with each discount resolve the conflict by indicating which discount should be applied. Although no more than one discount can be applied to a given item, any remaining discounts may still be eligible for application to other items. This process also applies to discounts on entire orders. Therefore, a user should consider the priority with which each discount will be assigned during discount definition time.

In one embodiment, the following types of discounts are available:

| | |
|---|---|
| Simple Discount | |
| Description | Buy a product at a reduced price. |
| Type | Per Item Discount. |
| Example | Buy an unlimited number of BEA backpacks at 25% |
| | off. |
| Discount Language | For each item where SKU = B123 (no limit) apply a |
| | 25% discount to each trigger item. |

Minimum Purchase Discount

| | |
|---|---|
| Description | Buy a minimum quantity of product and get each at |
| | a reduced price. |
| Type | Per Item Discount. |
| Example | Buy at least 3 CDs and get $1 off each CD. |
| Discount Language | For each item where Product Category = CD |
| | (minimum purchase = 3, no limit), apply a $1 off |
| | discount to each trigger item. |
| Note | The limit cannot be less than the minimum purchase |
| | requirement. |

Buy N, Get 1 Free Discount

| | |
|---|---|
| Description | Buy a certain quantity of a product and get one free. |
| Type | Set-based Discount. |
| Example | Buy 5 ties, get 1 free. |
| Discount Language | For the set of the following items, a set of 5 items |
| | where Product Category = Tie, apply a 100% dis- |
| | count to each of up to 1 item(s) where Product |
| | Category = Tie. |
| Paired Discount | |
| Description | Buy one product and get a price reduction on |
| | another product. |
| Type | Per Item Discount. |
| Example | Buy a bicycle and get a helmet at 50% off. |
| Discount Language | For each item where Product Category = Bicycle |
| | (limit = 1), apply a 50% discount to each of up to 1 |
| | item(s) where Product Category = Helmet. |
| Paired Set Discount | |
| Description | Buy a specified quantity of product and get a price |
| | reduction on another product. |
| Type | Set-based Discount. |
| Example | Buy 6 bottles of wine and get a wine rack at $10 off. |
| Discount Language | For the set of the following items: a set of 6 items |
| | where Product Category = Wine, apply a $10 off |
| | discount to each of up to 1 item(s) where Product |
| | Category = Wine Rack. |
| Bundle Discount | |
| Description | Buy a bundle of products at a reduced price. |
| Type | Set-based Discount. |
| Example | Buy home, Auto, and life insurance and get 20% |
| | off. |
| Discount Language | For the set of the following items: a set of 1 items |
| | where Product Category = Home and a set of 1 |
| | items |
| | where Product Category = Auto and a set of 1 items |
| | where Product Category = Life, apply a 20% |
| | discount to each trigger item. |

Paired Bundle Discount

| | |
|---|---|
| Description | Buy a bundle of products, get a price reduction on |
| | another product. |
| Type | Set-based Discount. |
| Example | Buy home and auto insurance and get life insurance |
| | at 15% off. |
| Discount Language | For the set of the following items: a set of 1 items |
| | where Product Category = Home and a set of 1 |
| | items |
| | where Product Category = Auto, apply a 15% dis- |
| | count to each of up to 1 item(s) where Product |
| | Category = Life. |
| Order Discount | |
| Description | Buy a certain total amount, get a price reduction on |
| | the order total (or shipping cost). |
| Type | Order Discount. |
| Example | Buy at least $500 worth of services, get 20% off. |
| Discount Language | For any order with a subtotal greater than or equal to |
| | $500 apply a 20% discount to the order total (or the |
| | shipping cost). |

Campaign discounts are discounts that are intended to be used within campaigns and awarded to specific customers under certain conditions, such as membership in a customer segment or specific customer behavior. An example of a discount used in a promotional campaign is, “if a Gold Customer clicks the Take-Advantage-of-This-Special-Offer advertisement banner, give the customer a 20% discount off books.” Discounts can be incorporated into promotional campaigns like advertisements and e-mails (as actions), and used in conjunction with these promotional messages to entice customers to buy products.

Since one predefined campaign discount can be applied within multiple campaigns, campaign discounts can have multiple discount explanations. A discount explanation identifies the discount to customers while they are checking out, or at some other time during their shopping experience. Having multiple discount explanations allows a user to tailor the text to the specific application of the discount. For campaign discounts, a user supply the discount explanation as a user are creating the discount scenario action (rather than during the discount definition, as is the case with stand-alone discounts).

Most promotional campaigns conceived within an organization will be developed within the context of a strategic business objective. By way of a non-limiting example, a user may want to run campaigns aimed at increasing average order size by employing cross-sell or up-sell tactics. However, a user can also use campaigns on internal Web sites. For example, Human Resources department can set up an employee portal and use campaigns to encourage employees to sign up for specific benefits.

By way of a non-limiting example, a user want to entice professional carpenters who buy circular saws from e-commerce Web site to buy saw blades as well. When a customer logs in, WebLogic Portal determines if the customer is in ProfessionalCarpenter customer segment. If so, and the customer places a circular saw in the shopping cart, then the shopping cart displays an advertisement for a 50% discount on saw blades. The customer places the saw blades into the shopping cart and receives the discounted price.

If business generates revenue by advertising products, an EBCC user can employ a campaign to do the following:

Run a test campaign to determine which customer type (customer segment) is most likely to select through a set of advertisements.

Based on the results of the test, target advertisements to maximize clickthroughs.

To try to maximize the number of advertisement clickthroughs, a user can run a test campaign to determine which customers are most likely to respond to the Jan's Roasted Coffee advertisement and at what times of day the advertisement clickthroughs are most likely to occur. Campaign analysis shows that adult females respond to advertisements for Jan's Roasted Coffee between the hours of 6 a.m. and 9 a.m. Using this information, a user can create a campaign to target advertisements to an AdultFemale customer segment during the specified hours. Since contract with Jan's Roasted Coffee is during the month of August, a user can set up the campaign to begin displaying coffee advertisements on August 1st and stop displaying them on September 1st.

In one embodiment, the EBCC provides a user with four scenario templates that a user can modify to quickly create scenarios for promotional campaigns. These are described in Table 4.

TABLE 4
Campaign Scenario Templates in an Embodiment

| TEMPLATE | DESCRIPTION |
|---|---|
| Registration | Demonstrates how a registration confirmation e- |
| Confirmation E-mail | mail can be sent to Web site customers. |
| Discount and | Displays a discount advertisement in conjunction |
| Advertisement | with an associated discount action. In other words, |
| Actions | if a customer sees the discount advertisement and as |
| | a result, purchases the item shown in the |
| | advertisement, the customer will receive a discount. |
| | This template is available only with WebLogic |
| | Portal. |
| Online Content Test | Tests advertisement effectiveness using probability- |
| | based branching. This scenario template, by |
| | default, targets equal thirds of the customers in the |
| | matching customer segments who visit the site |
| | while the campaign is running. A user can use this |
| | template to test the effectiveness of a single |
| | advertisement on different types of customers, or |
| | test multiple advertisements on a single type of |
| | customer. |
| E-mail Pilot Test | The Pilot Test template tests which of three e-mail |
| | messages is most effective. Each of the three |
| | messages is triggered by an event and is sent to a |
| | specific customer segment. Each e-mail is sent to a |
| | random sample within 5% of the customers |
| | matching the segment. It is expected that the e-mail |
| | generating the best response would be rolled out to |
| | a wider customer population. |

Though values will be predefined as part of the scenario templates, a user can change them to suit needs. A user will also need to provide specific values for any bracketed, undefined, hyperlinked text shown by selecting the terms or phrases in the appropriate editor window. However, a user may also choose to uncheck some of the conditions associated with the bracketed text, if a user choose to remove these hyperlinks instead.

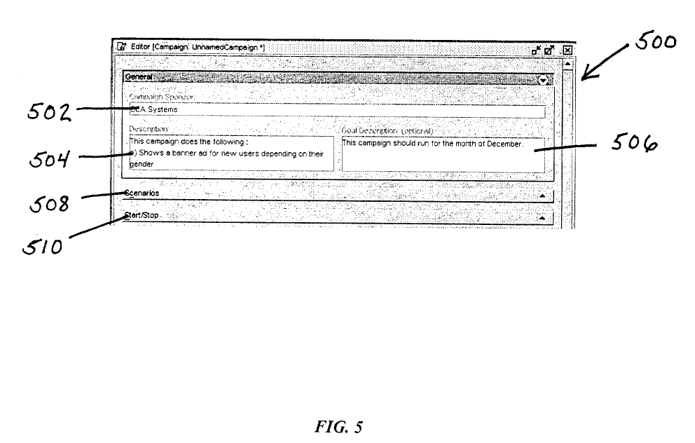

FIG. 5 is an illustration of a campaign editor in one embodiment of the invention. Campaign editor 500 can be used to create and modify user-defined campaigns. Field 502 allows an EBCC user to specify a campaign sponsor. Fields 504 and 506 allow the user to specify a textual description of the campaign and its goal, repetitively. Button 508 when selected allows the user to specify which scenario(s) are associated with the campaign. Start and stop conditions of the campaign can be specified using the Start/Stop button 510.

In one embodiment, a campaign is a named group of scenarios that work together to achieve strategic business goals. Scenarios, in turn, implement tactics in support of the campaign's strategic goals. Scenarios are comprised of scenario actions. The implementation of different scenarios is accomplished through each scenario's actions, which control the particular aspects of e-commerce website.

In one embodiment, the EBCC comes with three types of pre-configured scenario actions: advertisement, discount, and e-mail. The EBCC provides a variety of conditions that a user can use to trigger these scenario actions. Campaign attributes can include descriptive information about a campaign that can prove helpful to a user when dealing with the campaign in the future, e.g. the name of the campaign sponsor and a description of the campaign. Optionally, a user can specify a goal description for the campaign, such as “to entice circular saw buyers to add saw blades to their cart before check out.” All campaign attributes a user specifies can later be used as campaign search criteria.

Campaign sponsors are entities that have commissioned a campaign and on whose behalf the campaign is run. Often, the campaign sponsor will be the same as the organization who owns and operates the e-business Web site, or a department within that organization. However, the Web site owner may want to sell advertising on the site or enter into manufacturer or distributor sponsored campaigns. In such cases, the sponsor is different from the organization that owns the site. In the EBCC, the sponsor can be used as a criterion for campaign searches as well as for reporting and analysis purposes.

A campaign normally has a fixed duration, or period of time during which it is active. The EBCC will record campaign's starting and ending date and time. For campaigns using scenarios with advertisement actions, however, the EBCC also provides a user with another option: a campaign goal can be used to stop the campaign, prior to its scheduled end date. By way of a non-limiting example, the goal might be for a certain number of circular saw buyers to clickthrough an advertisement to another Web page that provides details about a saw blade discount. Or maybe a user just want a certain number of people to see advertisement (called an impression in the EBCC). In the EBCC, these goals are called campaign end criteria. When goal is satisfied-that is, when the number of advertisement clickthroughs or impressions reaches the number a user set-the campaign can end.

The EBCC allows a user to target customers for personalized content and messaging by creating dynamic groupings called customer segments. Every customer may be evaluated during their session in site or application to determine if they qualify for targeting as a member of one or more defined customer segments. In order to determine if a customer is a member of a given segment, each qualifying condition a user specifies is evaluated. Thus, a segment is a manageable way of bundling together two or more characteristics that represent a complex customer type.

Both scenarios and scenario actions can be targeted at segments. If segments are used in scenarios and its actions, the segments are evaluated as if they are connected with AND logic; that is, a customer can qualify as a member of both segments in order for the customer to be targeted in that campaign. The logic of AND-ing segments means that a user can use them to progressively narrow targeting without having to script new, even more complex segments.

Probability-based branching is a mechanism for dividing campaign scenario actions into proportional but random customer segments (subject to other conditions that may apply). Each time a scenario is evaluated to determine if any of its actions (advertisement, e-mail, or discount) apply to the customer, a random number between 1 and 100 is automatically generated by the system. If any action in the scenario includes a probability-based branching condition, then that number is used in its evaluation. If no scenario includes branching, then the number is forgotten, and a new random number is assigned for the next scenario in the campaign.

Branching is designed to provide two distinct capabilities:

Dictate that all the actions in a scenario be executed exclusive of each other (branching) and in some specific proportion to each other.

Scale down the number of times a scenario executes to some small percentage of all customers.

In the ordinary course of campaigns, each time a qualifying customer comes to the portal, that customer can be targeted with whatever promotional messages (advertisements and/or e-mails) and discounts are active. However, a user usually needs mutually exclusive populations for valid market tests. Therefore, the EBCC provides the ability to have a scenario run once only per customer. This feature is also pertinent in the case of e-mail campaigns. In many cases, a user will want customers to receive only one copy of a given promotion via e-mail.

In the EBCC, a user can create a scenario action that places a query in a specific advertisement placeholder when an event or some other state triggers the scenario. The query is kept in the placeholder until any of the following occurs:

The campaign achieves its goal for running the scenario query and displaying the corresponding advertisement.

The campaign ends because it has achieved some other goal, the end date/time for the campaign has arrived, or a business analyst ends the campaign in the EBCC.

An event or system state triggers another action for the scenario (or re-triggers the same action) that placed the query in the placeholder. Scenarios can contain multiple actions that place queries in one or more placeholders under different conditions.

The date/time that a user specifies in the Select Duration window (by clicking [the campaign ends] hyperlink in the Advertisement Action window) has expired.

A user can select the [Do not remove any other advertisements] hyperlink in an advertisement action and select one of the “Remove” options. When the action is triggered, the relevant queries are cleared.

A Webflow mechanism controls the presentation of web pages as customers interact with Web applications. To accomplish this, Webflow makes use of various components, some of which are designed to handle complex tasks like form validation or execution of back-end business processes. A Webflow comprises nodes and events. A node represents a state in the Webflow. Nodes are connected to each other to form flows of program control that enable portal navigation and input processing, much like elements in a software flowchart are connected. Depending on the node type, there are a number of predefined events that may occur (such as a customer clicking a link on a Web page). When a particular event happens, the Webflow decides which subsequent node to invoke to continue the flow.

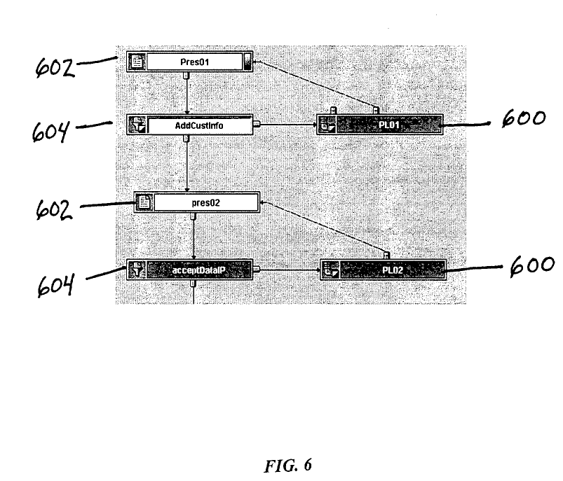

FIG. 6 is an illustration of a graphical Webflow editor in one embodiment of the invention. There are two main types of nodes: presentation nodes 602 and processor nodes 604. Each of the presentation and processor nodes can be used as origin or destination nodes within a Webflow. As their name implies, presentation nodes represent states in which the Webflow presents or displays something to a customer interacting with the Web application/portal. A Webflow can start and end with a presentation node. The form of the presentation can include:

HTML

JSPs

Java servlets

Processor nodes represent states in which the Webflow invokes more specialized components to handle activities like form validation, or back-end business logic that drives the site's presentation. The processor nodes available for use are:

Input Processors

Pipelines

A user can also create extension (custom) processor nodes for use in the Webflow. Input Processors 604 and Pipelines 600 are the two different types of processor nodes that come packaged with the Webflow implementation. Input Processors are predefined, specialized Java classes that carry out more complex tasks when invoked by the Webflow mechanism. Input Processors are typically used to validate HTML form data, or to provide conditional branching within a Web page. By way of a non-limiting example, an Input Processor may contain code that verifies whether a date has been entered in the correct format, as opposed to embedding that code within the same JSP that displays the form fields. Input Processors contain logic that is specific to the Web application, and are therefore loaded by the Web application's container.

A Pipeline is also a type of processor node that may be invoked by the Webflow. Pipelines initiate the execution of specific tasks related to business process, and can be transactional or nontransactional. By way of a non-limiting example, if a customer attempts to move to another page on Web site but a user want to persist the customer's information to a database first, a user could use a Pipeline. Pipelines contain business logic that may apply to multiple Web applications within a larger enterprise application, and are therefore loaded by the Enterprise JavaBean (EJB) container.

It is often necessary to keep track of information gathered from Web site customers, or to share the data modified by Pipeline Components and Input Processors as a customer moves through the site. A user may also want to access data that is part of a larger enterprise application, or make a process transactional. To accomplish these tasks, the Webflow mechanism makes use of a Pipeline Session. A Pipeline Session is an object that is created and stored within the HTTPRequest object. The Pipeline Session provides a single point of communication for all Pipeline Components in a given Pipeline. Input Processors also read data from the HTTPRequest and then use that data to create or update Java objects in the Pipeline Session. The Pipeline Session also provides central access and storage for external classes and also has transactional capabilities.

The Pipeline Session is comprised of many name/value pairs called attributes or properties. Pipeline Components, Input Processors, and external classes act on particular properties that exist within the Pipeline Session, and may also add new properties as necessary. All objects set in and retrieved from the Pipeline Session can be serializable.

Each node in a Webflow responds to events, which cause transitions (that is, movement from an origin node to a destination node). However, the types of events a node responds to depends on whether the node is a presentation node or a processor node. Presentation nodes respond to the following events:

Links

Buttons

When a customer to the Web site clicks a link or a button, the Webflow responds to that event. A response might be to transition to another presentation node (such as a JSP) or to a processor node (such as an Input Processor to validate customer-provided form data). In contrast, processor nodes respond to the following events:

Exceptions

Return objects

Although a user will generally have only one Webflow per Web application, namespaces allow a user to divide Webflow into a number of smaller, more manageable modules. This modularity may make development team more productive by allowing individual developers to simultaneously work with various portions of a Web application, without having to worry about naming collisions. For example, a Pipeline Component defined in one namespace can access a variable defined in another namespace, then redirect to a JSP defined in yet a third namespace. There can be any number of namespaces within a Webflow, but namespaces can only be one level deep. In other words, a user can not nest namespaces.

In addition to the Webflow components previously described, there are four Webflow components that perform special functions in a Webflow. These are described in Table 5.

TABLE 5
Node Descriptions in an Embodiment

| NODE | DESCRIPTION |
|---|---|
| Begin | Typically, a begin node is a node designated as the initial |
| | entry point or state of the Webflow, which automatically |
| | transitions to a presentation or processor node. The begin |
| | node is generally a presentation node in the form of a |
| | JavaServer Page (JSP). If a URL does not specify an |
| | origin, namespace, or event, the Webflow mechanism |
| | looks for a begin node in the default namespace. If one is |
| | located, the begin node is used as the starting point for |
| | the customer's interaction with the application. There- |
| | fore, although the begin node is optional, we recommend |
| | that a user have at least one defined in default |
| | namespace. A user can have more than one begin node in |
| | a Webflow (one for each namespace). If a namespace |
| | specified in the URL has its own begin node, the |
| | Webflow will use that begin node before looking for a |
| | begin node in the default namespace. A user can also use |
| | a begin node as a destination node in a Webflow |
| | transition. |
| Root | A root component node is analogous to the begin node |
| Component | for a Webflow, only it is the entry point into or initial |
| | state of a Pipeline. A user can have one (and only one) |
| | root component node per Pipeline. |
| Wildcard | If the Webflow cannot locate a specific presentation or |
| | processor node to complete a transition, the Webflow |
| | will search for a wildcard presentation or processor node |
| | to use as the origin node. Therefore, wildcard presenta- |
| | tion nodes and wildcard processor nodes implement de- |
| | fault behavior for Web application. Put another way, |
| | wildcard nodes allow a user to abstract common func- |
| | tionality and to locate that functionality in a single place |
| | in Webflow. Wildcard nodes are used only when |
| | destination nodes are not explicitly defined in the Web- |
| | flow. A user may have one wildcard presentation node |
| | and one wildcard processor node per namespace. |
| Configuration | The configuration error page is essentially a presentation |
| Error Page | node whose primary purpose is to display debugging |
| | information when there is a configuration error in the |
| | Webflow. If the Webflow mechanism cannot locate the |
| | destination for a transition after exhausting a list of |
| | possible choices, the Webflow will instead display the |
| | configuration error page a user defined. Much like a user |
| | can move from one presentation node (such as a JSP) to |
| | another, a user can also move from one processor node |
| | (such as an Input Processor) to another processor node. |
| | In other words, a user do not necessarily need to use |
| | processor nodes in between presentation nodes. For |
| | processor nodes, this movement is called chaining. In a |
| | chaining arrangement, the result state of one successfully |
| | executed processor node is another processor node. |
| Presentation | A page display to visitors interacting with your Web |
| Node | application. The type of these pages can be HTML, JSP, |
| | Java servlet, or an Extension (Cutom) Presenttion Node. |
| Wildcard | A single, global event contained on one or more Pre- |
| Presentation | sentation Nodes, typically used to implement general |
| Node | functions. There may be several Wildcard Presentation |
| | Nodes within a Weblow namespace. The type property |
| | reflects the context in which the vent occurs. |
| Extention | A node created by an experienced Java/EJB developer for |
| (Custom) | use in a Webflow. To appear in the Webflow Editor, this |
| Presentation | node can have an equivalent server-side Java class repre- |
| Node | sentation and be registered in the webflow- |
| | extensions.wfx file. |
| Input Processor | A processor Webflow component that handles data input, |
| Node | whether from Web site visitors or other processor nodes. |
| | Validation of data input is the typical use of an Input |
| | Processor. |
| Pipeline Node | A processor Webflow component that encapsulates |
| | business logic for a Web application. Pipelines Nodes |
| | contain a series of Pipeline Component Nodes, the latte |
| | of which are editable in the Pipeline Editor. |
| Wildcard | A single, global event contained on one or more |
| Processor Node | Processor Nodes, typically used to implement general |
| | functions. There may be several Wildcard Processor |
| | Nodes within a Webflow namespace. The type property |
| | reflects the context in which the event occurs. |
| Extension | A node created by an experienced Java/EJB developer for |
| (Custom | use in a Webflow. To appear in the Webflow Editor, this |
| Processor Node | node can have an equivalent server-side Java class |
| | representation and be registered in the webflow- |
| | extensions.wfx file. |
| Begin Node | A node designated as the initial state of or entry point |
| | into the Webflow. There can be one Begin Node for each |
| | namespace in a Webflow. The Begin Node can also be |
| | used as a destination. |
| Proxy Node | A special node that represents a node whose definition |
| | resides in a different namespace file. Nodes in the |
| | namespace being edited can refer to the Proxy Node as a |
| | destination, but the Proxy Node itself cannot be edited. |
| | Proxy Nodes can be Presentation Nodes, Processor |
| | Nodes, or Extension (Custom) Nodes. |
| Event | An occurrence triggered by the interaction of a Web site |
| (may be a link, | visitor that results in some change in the state of the |
| button, or re- | Webflow. In other words, events cause Webflow transi- |
| turn object) | tions (movement from an origin node to a destination |
| | node). There are different events for different node types: |
| | link and button are events for Presentation Nodes: return |
| | object is an event for a Processor Node that has executed |
| | successfully. |
| Exception | Representation of an exception, which occurs when |
| | Processor Nodes do not execute successfully. |
| Pipeline | A specialized Webflow component that performs tasks |
| Component | related to the application's underlying business logic. |
| Node | Pipeline Components exist within Pipelines, and may be |
| | implemented as Java objects or stateless session EJBs. |
| Root Node | A Pipeline Component that represents the initial entry |
| | point into the Pipeline. There can be one Root Node for |
| | each Pipeline. The Root Node can also be used as a |
| | destination. |
| About Excep- | A special node that represents the place where a |
| tion Node | Pipeline's exceptions connect to, because their destina- |
| | tions actually exist outside the Pipeline Editor (in the |
| | Webflow Editor) |
| Event (return | An occurrence triggered by the successful execution of a |
| object) | Pipeline Component that results in some change in the |
| | state of the Webflow. In other words, events cause |
| | Webflow transitions (movement from an origin node to a |
| | destination node). There are different events for different |
| | node types: return objects is an event for a Pipeline |
| | Component Node that has executed successfully. |
| Exception. | Special event type triggered by a Pipeline Component |
| | Node when it does not execute successfully. |

In one embodiment, the EBCC includes a Webflow Editor and a Pipeline Editor designed to help a user create, modify, and validate Webflow and Pipeline XML configuration files. The Webflow Editor displays and requires that a user work with Webflow components within individual namespaces. In addition to allowing different developers to work in different areas of the same Webflow, displaying a Webflow by namespace in the Webflow Editor provides a much cleaner visualization, and thus may reduce the likelihood of error. Since the Webflow and Pipeline Editors are graphical tools for creating and modifying Webflows and Pipelines, each Webflow component has a graphical representation for display in an Editor. In one embodiment, flow control from an origin node to a destination node result from events or exceptions thrown by the origin node. A user can connect two different nodes with event and exception transitions, or a user can create self-referring transitions (a transition that has the same origin and destination node).

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. An interactive tool for configuring an enterprise application, comprising:
a first graphical user interface (GUI) to create and/or manage a segment;
a second GUI to create and/or manage a promotional campaign wherein the promotional campaign contains at least one scenario; and/or
a third GUI to create and/or manage at least one of (1) a query and (2) a condition.

2. The interactive tool of claim 1 wherein:
the condition can determine whether (1) a customer is a member of a predefined customer segment, (2) a customer has specific characteristics, (3) a hypertext transfer protocol (HTTP) session has specific properties, (4) an HTTP request has specific properties, (5) an event has occurred, (6) an event has specific characteristics, (7) a first date is equal to a second date, (8) a first date is follows a second date, (9) a first date and time follows a second date and time, (10) a first time is between a second time and a third time, (11) a first date is between a second date and a third date, (12) a first date and time is between a second date and time and a third date and time, (13) there is a specific item in a shopping cart, (14) there is an item from a given category in a shopping cart, (15) the value of items in a shopping cart is at or above a certain amount, and/or (16) a random number falls within a given range.

3. The interactive tool of claim 1 wherein:
the query can be used to search a content management system to retrieve a document.

4. The interactive tool of claim 1 wherein:
the query can be used to compare a document property to at least one of (1) a value or a range of values and (2) a property of another object.

5. The interactive tool of claim 1 wherein:
the segment can be used to control customer access to content in a portal.

6. The interactive tool of claim 1 wherein:
the at least one scenario can be triggered by the segment.

7. The interactive tool of claim 1 wherein:
the segment can be used to determine whether a customer belongs to a particular population segment based on the at least one condition.

8. The interactive tool of claim 1 wherein:
the at least one scenario includes at least one scenario action.

9. The interactive tool of claim 8 wherein:
the at least one scenario action can be triggered by the segment.

10. The interactive tool of claim 8 wherein:
the at least one scenario action can be one of (1) an advertisement, (2) a discount, and (3) an electronic mail message.

11. The interactive tool of claim 8 wherein:
the at least one scenario action can be triggered using probability-based branching.

12. The interactive tool of claim 1 further comprising:
a fourth GUI to create and/or manage a Webflow wherein the Webflow can include at least one of (1) an input processor, and (2) a pipeline.

13. The interactive tool of claim 1 further comprising:
a fifth GUI to create and/or manage a discount wherein the discount can be (1) per item, (2) set-based or (3) order-based.

14. The interactive tool of claim 1 further comprising:
a sixth GUI to create and/or manage a placeholder wherein the placeholder can include at least one advertisement query.

15. The interactive tool of claim 14 wherein:
the placeholder can use a priority to determine which of the at least one advertisement queries to execute.

16. The interactive tool of claim 14 wherein:
the placeholder can use a weight to determine an advertisement to display when the at least one advertisement query returns more than one result.

17. An interactive tool for configuring an enterprise application, comprising:
a first graphical user interface (GUI) to create and/or manage a segment;
a second GUI to create and/or manage a promotional campaign wherein the promotional campaign contains at least one scenario;
a third GUI to create and/or manage at least one of (1) a query and (2) a condition; and
a fourth GUI to create and/or manage a Webflow wherein the Webflow can include at least one of (1) an input processor, and (2) a pipeline.

18. The interactive tool of claim 17 wherein:
the query can be used to search a content management system to retrieve a document.

19. The interactive tool of claim 17 wherein:
the query can be used to compare a document property to at least one of (1) a value or a range of values and (2) a property of another object.

20. The interactive tool of claim 17 wherein:
the segment can be used to control customer access to content in a portal.

21. The interactive tool of claim 17 wherein:
the at least one scenario can be triggered by the segment.

22. The interactive tool of claim 17 wherein:
the segment can be used to determine whether a customer belongs to a particular population segment based on the at least one condition.

23. The interactive tool of claim 17 wherein:
the at least one scenario includes at least one scenario action.

24. The interactive tool of claim 23 wherein:
the at least one scenario action can be triggered by the segment.

25. The interactive tool of claim 23 wherein:
the at least one scenario action can be one of (1) an advertisement, (2) a discount, and (3) an electronic mail message.

26. The interactive tool of claim 23 wherein:
the at least one scenario action can be triggered using probability-based branching.

27. The interactive tool of claim 17 further comprising:
a fifth GUI to create and/or manage a discount wherein the discount can be (1) per item, (2) set-based or (3) order-based.

28. The interactive tool of claim 17 further comprising:
a sixth GUI to create and/or manage a placeholder wherein the placeholder can include at least one advertisement query.

29. The interactive tool of claim 28 wherein:
the placeholder can use a priority to determine which of the at least one advertisement queries to execute.

30. The interactive tool of claim 28 wherein:
the placeholder can use a weight to determine an advertisement to display when the at least one advertisement query returns more than one result.

31. A method for a configuring an enterprise application, comprising:
providing a first graphical user interface (GUI) to create and/or manage a segment;
providing a second GUI to create and/or manage a promotional campaign wherein the promotional campaign contains at least one scenario; and
providing a third GUI to create and/or manage at least one of (1) a query and (2) a condition.

32. The method of claim 31 wherein:
the condition can determine whether (1) a customer is a member of a predefined customer segment, (2) a customer has specific characteristics, (3) a hypertext transfer protocol (HTTP) session has specific properties, (4) an HTTP request has specific properties, (5) an event has occurred, (6) an event has specific characteristics, (7) a first date is equal to a second date, (8) a first date is follows a second date, (9) a first date and time follows a second date and time, (10) a first time is between a second time and a third time, (11) a first date is between a second date and a third date, (12) a first date and time is between a second date and time and a third date and time, (13) there is a specific item in a shopping cart, (14) there is an item from a given category in a shopping cart, (15) the value of items in a shopping cart is at or above a certain amount, and/or (16) a random number falls within a given range.

33. The method of claim 31 wherein:
the query can be used to search a content management system to retrieve a document.

34. The method of claim 31 wherein:
the query can be used to compare a document property to at least one of (1) a value or a range of values and (2) a property of another object.

35. The method of claim 31 wherein:
the segment can control customer access to content in a portal.

36. The method of claim 31 wherein:
the at least one scenario can be triggered by the segment.

37. The method of claim 31 wherein:
the segment can determine whether a customer belongs to a particular population segment based on at least one condition.

38. The method of claim 31 wherein:
the at least one scenario includes at least one scenario action.

39. The method of claim 38 wherein:
the at least one scenario action can be triggered by the segment.

40. The method of claim 38 wherein:
the at least one scenario action can be one of (1) an advertisement, (2) a discount, and (3) an electronic mail message.

41. The method of claim 38 wherein:
the at least one scenario action can be triggered using probability-based branching.

42. The method of claim 31 further comprising:
providing a fourth GUI to create and/or manage portals.

43. The method of claim 31 further comprising:
providing a fifth GUI to create and/or manage portlets.

44. The method of claim 31 further comprising:
providing a sixth GUI to create and/or manage a Webflow wherein the Webflow can include at least one of (1) an input processor, and (2) a pipeline.

45. The method of claim 31 further comprising:
providing a seventh GUI to create and/or manage a discount wherein the discount can be (1) per item, (2) set-based or (3) order-based.

46. The method of claim 31 further comprising:
providing an eighth GUI to create and/or manage a placeholder wherein the placeholder can include at least one advertisement query.

47. The method of claim 46 wherein:
the placeholder can use a priority to determine which of the at least one advertisement queries to execute.

48. The method of claim 46 wherein:
the placeholder can use a weight to determine an advertisement to display when the at least one advertisement query returns more than one result.

49. A machine readable medium having instructions stored thereon that when executed by a processor cause a system to:
provide a first graphical user interface (GUI) to create and/or manage a segment;
provide a second GUI to create and/or manage a promotional campaign wherein the promotional campaign contains at least one scenario; and
provide a third GUI to create and/or manage at least one of (1) a query and (2) a condition.

50. The machine readable medium of claim 49 wherein:
the condition can determine whether (1) a customer is a member of a predefined customer segment, (2) a customer has specific characteristics, (3) a hypertext transfer protocol (HTTP) session has specific properties, (4) an HTTP request has specific properties, (5) an event has occurred, (6) an event has specific characteristics, (7) a first date is equal to a second date, (8) a first date is follows a second date, (9) a first date and time follows a second date and time, (10) a first time is between a second time and a third time, (11) a first date is between a second date and a third date, (12) a first date and time is between a second date and time and a third date and time, (13) there is a specific item in a shopping cart, (14) there is an item from a given category in a shopping cart, (15) the value of items in a shopping cart is at or above a certain amount, and/or (16) a random number falls within a given range.

51. The machine readable medium of claim 49 wherein:
the query can be used to search a content management system to retrieve a document.

52. The machine readable medium of claim 49 wherein:
the query can be used to compare a document property to at least one of (1) a value or a range of values and (2) a property of another object.

53. The machine readable medium of claim 49 wherein:
the segment can be used to control customer access to content in a portal.

54. The machine readable medium of claim 49 wherein:
the at least one scenario can be triggered by the segment.

55. The machine readable medium of claim 49 wherein:
the segment can be used to determine whether a customer belongs to a particular population segment based on the at least one condition.

56. The machine readable medium of claim 49 wherein:
the at least one scenario includes at least one scenario action.

57. The machine readable medium of claim 56 wherein:
the at least one scenario action can be triggered by the segment.

58. The machine readable medium of claim 56 wherein:
the at least one scenario action can be one of (1) an advertisement, (2) a discount, and (3) an electronic mail message.

59. The machine readable medium of claim 56 wherein:
the at least one scenario action can be triggered using probability-based branching.

60. The machine readable medium of claim 49, further comprising instructions that when executed by a processor cause the system to:
provide a fourth GUI to create and/or manage a Webflow wherein the Webflow can include at least one of (1) an input processor, and (2) a pipeline.

61. The machine readable medium of claim 49, further comprising instructions that when executed by a processor cause the system to:
provide a fifth GUI to create and/or manage a discount wherein the discount can be (1) per item, (2) set-based or (3) order-based.

62. The machine readable medium of claim 49, further comprising instructions that when executed by a processor cause the system to:
provide a sixth GUI to create and/or manage a placeholder wherein the placeholder can include at least one advertisement query.

63. The machine readable medium of claim 62 wherein:
the placeholder can use a priority to determine which of the at least one at least one advertisement queries to execute.

64. The machine readable medium of claim 62 wherein:
the placeholder can use a weight to determine an advertisement to display when the at least one advertisement query returns more than one result.
